(19) United States
(12) Patent Application Publication
(10) Pub. No.: US 2020/0089407 A1
(43) Pub. Date: Mar. 19, 2020

(54) INTER ZONE WRITE FOR ZONED NAMESPACES

(71) Applicant: Intel Corporation, Santa Clara, CA (US)

(72) Inventors: Jim S. Baca, Longmont, CO (US); Shirish Bahirat, Longmont, CO (US); Daniel Naaykens, Vancouver (CA)

(73) Assignee: Intel Corporation, Santa Clara, CA (US)

(21) Appl. No.: 16/692,090

(22) Filed: Nov. 22, 2019

(51) Int. Cl. G06F 3/06

(52) U.S. Cl. CPC G06F 3/064; G06F 3/0614; G06F 3/0679; G06F 3/0659; G06F 3/061

(57) ABSTRACT

An embodiment of an electronic apparatus may include one or more substrates, and logic coupled to the one or more substrates, the logic to control access to a persistent storage device which is logically organized with a namespace divided into two or more zones, receive a write request for a first zone of the two or more zones of the namespace, determine if the first zone can accommodate the write request, and span the write request across a second zone of the two or more zones of the namespace if the first zone cannot accommodate the write request. Other embodiments are disclosed and claimed.

### BACKGROUND

Conventional hard disk drives (HDDs) may utilize shingled magnetic recording (SMR) technology. Non-volatile memory (NVM) storage devices, such as NAND-based solid state drives (SSDs) may utilize a flash transition layer (FTL) to manage the NAND-based media. An NVM Express (NVMe) specification (NVMe 2.0 base specification, nvmexpress.org), provides for utilization of Zoned Namespaces (ZNS). The ZNS interface may be considered similar to the SMR interface. Both interfaces require sequential writes to a zone.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a block diagram of an example of an electronic storage system according to an embodiment;

FIG. 2 is a block diagram of an example of an electronic apparatus according to an embodiment;

FIGS. 3A to 3D are flowcharts of an example of a method of controlling storage according to an embodiment;

FIG. 4 is an illustrative diagram of an example of a zoned namespace according to an embodiment;

FIG. 5 is a flowchart of an example of another method of controlling storage according to an embodiment;

FIG. 6 is a flowchart of an example of another method of controlling storage according to an embodiment;

FIG. 7 is an illustrative diagram of an example of a zone state machine according to an embodiment;

FIG. 8 is a block diagram of an example of a computing system according to an embodiment; and

FIG. 9 is a block diagram of an example of a SSD according to an embodiment.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smartphones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

Methods, devices, systems, and articles are described herein related to storage systems. More particularly, some embodiments relate to an improved dynamic single level cell memory controller.

Various embodiments described herein may include a memory component and/or an interface to a memory component. Such memory components may include volatile and/or nonvolatile (NV) memory. Volatile memory may be a storage medium that requires power to maintain the state of data stored by the medium. Non-limiting examples of volatile memory may include various types of random access memory (RAM), such as dynamic RAM (DRAM) or static RAM (SRAM). One particular type of DRAM that may be used in a memory module is synchronous dynamic RAM (SDRAM). In particular embodiments, DRAM of a memory component may comply with a standard promulgated by Joint Electron Device Engineering Council (JEDEC), such as JESD79F for double data rate (DDR) SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at jedec.org). Such standards (and similar standards) may be referred to as DDR-based standards and communication interfaces of the storage devices that implement such standards may be referred to as DDR-based interfaces.

NVM may be a storage medium that does not require power to maintain the state of data stored by the medium. In one embodiment, the memory device may include a block addressable memory device, such as those based on NAND or NOR technologies. A memory device may also include future generation nonvolatile devices, such as a three dimensional (3D) crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor RAM (FeTRAM), anti-ferroelectric memory, magnetoresistive RAM (MRAM) memory that incorporates memristor technology, resistive memory including the metal oxide base, the oxygen vacancy base and the conductive bridge RAM (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The memory device may refer to the die itself and/or to a packaged memory product. In particular embodiments, a memory component with non-volatile memory may comply with one or more standards promulgated by the JEDEC, such as JESD218, JESD219, JESD220-1, JESD223B, JESD223-1, or other suitable standard (the JEDEC standards cited herein are available at jedec.org).

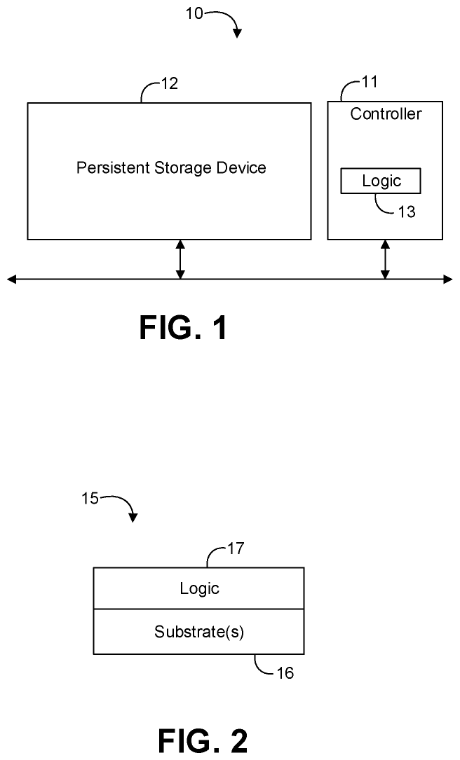

With reference to FIG. 1, an embodiment of an electronic storage system 10 may include a persistent storage device 12 logically organized with a namespace divided into two or more zones, and a controller 11 coupled to the persistent storage device 12. The controller 11 may include logic 13 to receive a write request for a first zone of the two or more zones of the namespace, determine if the first zone can accommodate the write request, and span the write request across a second zone of the two or more zones of the namespace if the first zone cannot accommodate the write request. If the first zone cannot accommodate the write request, for example, the logic 13 may be configured to determine if a zone adjacent to the first zone is uninitialized, and if so determined, to initialize the adjacent zone to provide the second zone, and continue the write request with the second zone. In some embodiments, if the adjacent zone is determined to be already initialized the logic 13 may be further configured to query a host to re-initialize the adjacent zone, and if the re-initialize query is accepted by the host, to initialize the adjacent zone to provide the second zone, and continue the write request with the second zone.

In some embodiments, the logic 13 may be configured to determine if the first zone is full, and if so determined, to identify an empty zone, reset the empty zone to provide the second zone, and continue the write request with the second zone. For example, the logic 13 may be further configured to manage a pointer to link the second zone to the first zone, and/or to query a host to identify the empty zone. In any of the embodiments herein, the persistent storage device 12 may include a SSD (e.g., a NAND-based SSD).

Embodiments of each of the above controller 11, persistent storage device 12, logic 13, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof. Embodiments of the controller 11 may include a general purpose controller, a special purpose controller, a memory controller, a storage controller, a micro-controller, a general purpose processor, a special purpose processor, a central processor unit (CPU), an execution unit, etc. In some embodiments, the persistent storage device 12, and/or the logic 13 may be located in, or co-located with, various components, including the controller 11 (e.g., on a same die).

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the persistent storage device 12, other persistent storage media, or other system memory may store a set of instructions which when executed by the controller 11 cause the system 10 to implement one or more components, features, or aspects of the system 10 (e.g., the logic 13, receiving the write request for a first zone of the two or more zones of the namespace, determining if the first zone can accommodate the write request, spanning the write request across a second zone of the two or more zones of the namespace if the first zone cannot accommodate the write request, etc.).

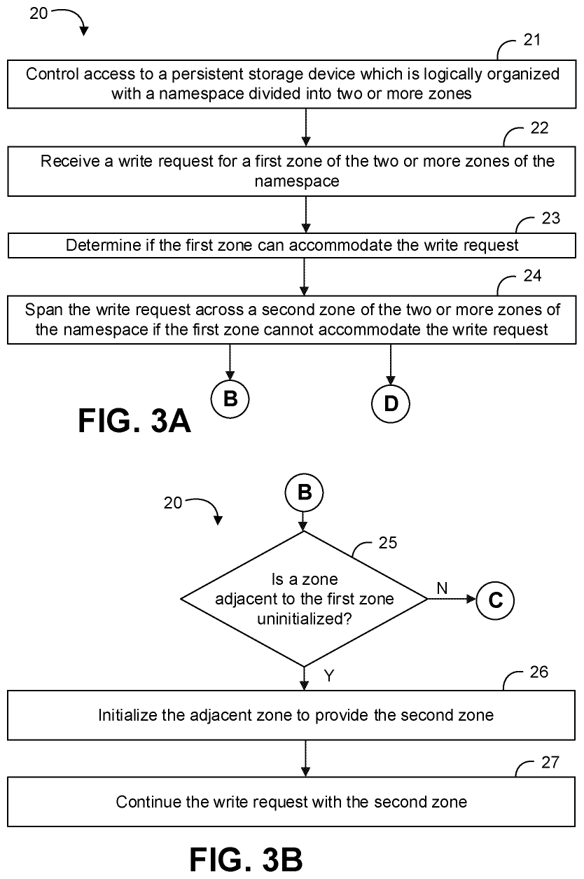

Turning now to FIG. 2, an embodiment of an electronic apparatus 15 may include one or more substrates 16, and logic 17 coupled to the one or more substrates 16. The logic 17 may be configured to control access to a persistent storage device which is logically organized with a namespace divided into two or more zones, receive a write request for a first zone of the two or more zones of the namespace, determine if the first zone can accommodate the write request, and span the write request across a second zone of the two or more zones of the namespace if the first zone cannot accommodate the write request. If the first zone cannot accommodate the write request, for example, the logic 17 may be configured to determine if a zone adjacent to the first zone is uninitialized, and if so determined, to initialize the adjacent zone to provide the second zone, and continue the write request with the second zone. In some embodiments, if the adjacent zone is determined to be already initialized the logic 17 may be further configured to query a host to re-initialize the adjacent zone, and if the re-initialize query is accepted by the host, to initialize the adjacent zone to provide the second zone, and continue the write request with the second zone.

In some embodiments, the logic 17 may be configured to determine if the first zone is full, and if so determined, to identify an empty zone, reset the empty zone to provide the second zone, and continue the write request with the second zone. For example, the logic 17 may be further configured to manage a pointer to link the second zone to the first zone, and/or to query a host to identify the empty zone. In any of the embodiments herein, the persistent storage device may include a SSD (e.g., a NAND-based SSD).

Embodiments of the logic 17 may be implemented in a system, apparatus, computer, device, etc., for example, such as those described herein. More particularly, hardware implementations of the logic 17 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the logic 17 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the logic 17 may be implemented on a semiconductor apparatus which may include the one or more substrates 16, with the logic 17 coupled to the one or more substrates 16. In some embodiments, the logic 17 may be at least partly implemented in one or more of configurable logic and fixed-functionality hardware logic on semiconductor substrate(s) (e.g., silicon, sapphire, gallium-arsenide, etc.). For example, the logic 17 may include a transistor array and/or other integrated circuit components coupled to the substrate(s) 16 with transistor channel regions that are positioned within the substrate(s) 16. The interface between the logic 17 and the substrate(s) 16 may not be an abrupt junction. The logic 17 may also be considered to include an epitaxial layer that is grown on an initial wafer of the substrate(s) 16.

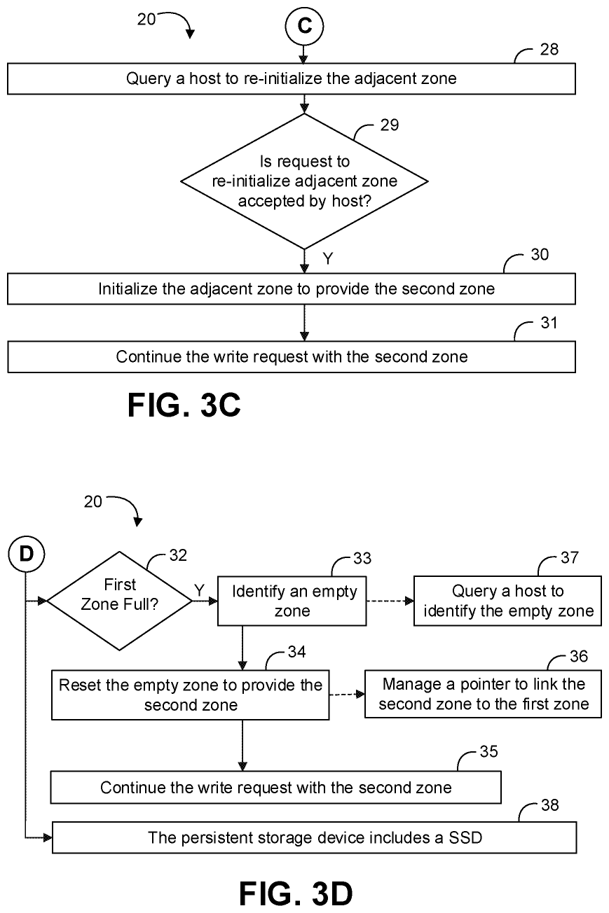

Turning now to FIGS. 3A to 3D, an embodiment of a method 20 of controlling storage may include controlling access to a persistent storage device which is logically organized with a namespace divided into two or more zones at block 21, receiving a write request for a first zone of the two or more zones of the namespace at block 22, determining if the first zone can accommodate the write request at block 23, and spanning the write request across a second zone of the two or more zones of the namespace if the first zone cannot accommodate the write request at block 24. If the first zone cannot accommodate the write request, for example, the method 20 may further include determining if a zone adjacent to the first zone is uninitialized at block 25, and if so determined, the method 20 may include initializing the adjacent zone to provide the second zone at block 26, and continuing the write request with the second zone at block 27. If the adjacent zone is determined to be already initialized at block 25, for example, the method 20 may further include querying a host to re-initialize the adjacent zone at block 28, and if the re-initialize query is accepted by the host at block 29, the method 20 may include initializing the adjacent zone to provide the second zone at block 30, and continuing the write request with the second zone at block 31.

Some embodiments of the method 20 may further include determining if the first zone is full at block 32, and if so determined, the method 20 may include identifying an empty zone at block 33, resetting the empty zone to provide the second zone at block 34, and continuing the write request with the second zone at block 35. For example, the method 20 may further include managing a pointer to link the second zone to the first zone at block 36, and/or querying a host to identify the empty zone at block 37. In any of the embodiments herein, the persistent storage device may include a SSD at block 38.

Embodiments of the method 20 may be implemented in a system, apparatus, computer, device, etc., for example, such as those described herein. More particularly, hardware implementations of the method 20 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 20 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 20 may be implemented on a computer readable medium as described in connection with Examples 22 to 28 below. Embodiments or portions of the method 20 may be implemented in firmware, applications (e.g., through an application programming interface (API)), or driver software running on an operating system (OS). Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Some embodiments may advantageously provide technology to enable ZNS inter zone writes for SSDs. For example, ZNS technology may enable a SSD to be more effectively utilized in the cold data storage space or other applications supported by SMR HDDs. In order for an SSD to act more like a traditional HDD, ZNS requires the use of sequential data writes in a single zone. Some embodiments may advantageously enable write commands that span across zones when zone capacity is full. For example, some embodiments may provide technology to allow SSDs enabled with ZNS capabilities to support write commands that span across to an adjacent empty zone when current zone capacity is full. Advantageously, rather than writes failing due to reaching the end of a zone's physical space, the ability to span to the next zone allows the SSD to continue the contiguous write. Some embodiments also advantageously reduce host OS overhead because the host does not necessarily have to manage zones and their sizes. Even where a number of zones and/or the zone size is known by the host, a large amount of data written to the device which exceeds the size of the zone may continue the write into another zone instead of having the drive return an error. In accordance with some embodiments, a suitably configured SSD may be able to sequentially write past the end of a zone, and/or enable ZNS without requiring manually setting the size of a zone.

As described in the NVMe 2.0 base specification, ZNS may utilize Zones with one or more of the following requirements: Zones create fixed size partitions of logical block addresses (LBAs) in a namespace; Zones support sequential write access, and random read access; Zone data is not moved by the device; Zones must be explicitly reset to allow overwrites; and/or Zones only support an integer number of LBAs, and thus a multiple of the Zone size in writes/data. Some embodiments advantageously provide one or more additional functional capabilities to zoned namespaces.

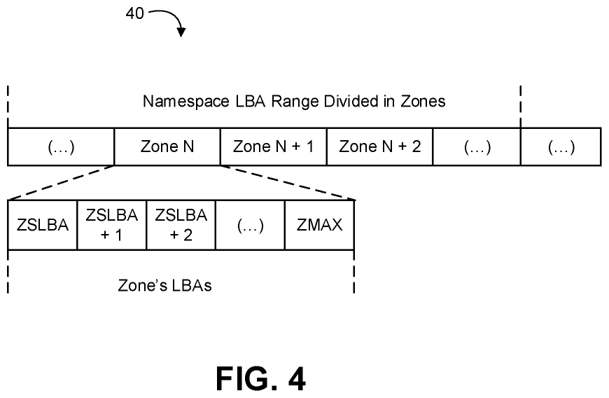

With reference to FIG. 4, an embodiment of a zoned namespace 40 may include a namespace range divided in zones including Zone N, Zone N+1, Zone N+2, etc., where N>0. Each Zone has a range of LBAs starting from the zone starting logical block address (ZSLBA) through ZMAX, where ZMAX=ZSLBA+ZSIZE (the size of the zone). With conventional ZNS technology, a write request which goes beyond ZMAX will be rejected and a drive error will be returned. Advantageously, some embodiments may extend ZNS technology to enable a write request which goes beyond ZMAX to continue in another zone of the namespace (e.g., Zone N+1, Zone N+2, etc.). Some embodiments may automatically determine if the adjacent zone is empty and, if so, reset the adjacent zone and continue the write in the adjacent zone without interruption or host intervention. Additionally, or alternatively, some embodiments may query the host to identify a suitable zone to continue the write and, based on the host's response, reset the identified zone and continue the write, or return an error if no suitable zone is identified by the host.

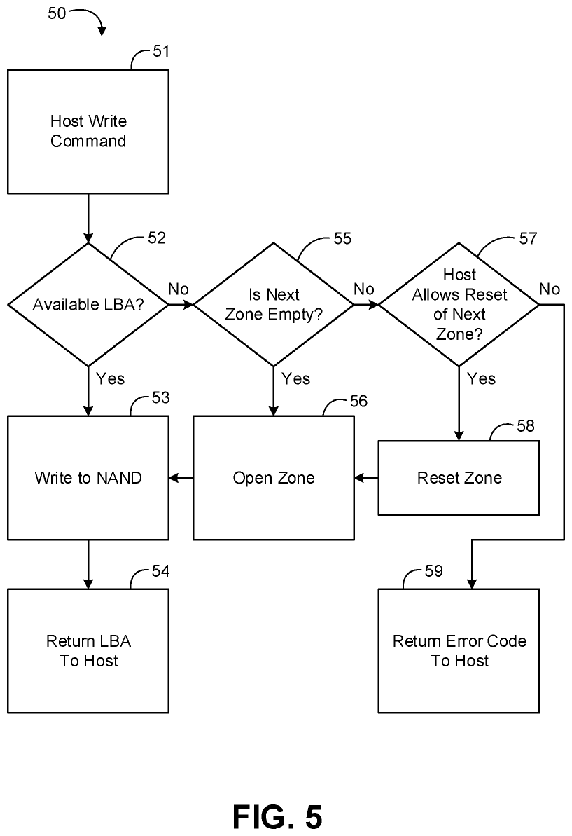

With reference to FIG. 5, an embodiment of a method 50 of controlling storage may include receiving a host write command at block 51 and determining if there is an available LBA to complete the write at block 52. If so, the method 50 may include performing the write to NAND media at block 53 and returning the LBA for the write to the host at block 54. If there is no available LBA to complete the write at block 52, the method 50 may include determining if the next zone is empty at block 55. If so, the method 50 may include opening the next zone at block 56, and then continuing with performing the write to NAND media at block 53 and returning the LBA to the host at block 54. If the next zone is determined to already be open at block 55 (e.g., not empty), the method 50 may include querying the host to determine if the host allows reset of the next zone at block 57. If so, the method 50 may include resetting the next zone at block 58, opening the next zone at block 56, and then continuing with performing the write to NAND media at block 53 and returning the LBA to the host at block 54. If not, the method 50 may include returning an error code to the host at block 59.

Advantageously, by automatically extending host writes to the next zone (if empty), some embodiments of a storage device may reduce host bus (e.g., NVMe) utilization and a number of administration commands between the device and host. If the adjacent zone has not been initialized, for example, the drive will independently open the zone and continue to accept write/append commands. Any suitable pointer/LBA management technology may be utilized to manage the contiguous writes to the NAND media across adjacent zones (e.g., lookup tables, indirection tables, etc.).

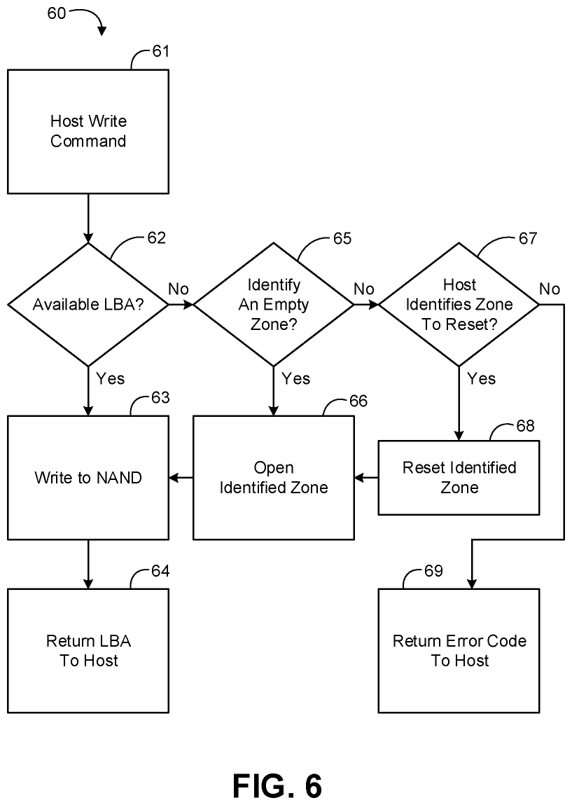

With reference to FIG. 6, an embodiment of a method 60 of controlling storage may include receiving a host write command at block 61 and determining if there is an available LBA to complete the write at block 62. If so, the method 60 may include performing the write to NAND media at block 63 and returning the LBA for the write to the host at block 64. If there is no available LBA to complete the write at block 62, the method 60 may include identifying an empty zone at block 65. If any empty zone is identified at block 65, the method 60 may include opening the identified zone at block 66, and then continuing with performing the write to NAND media at block 63 and returning the LBA to the host at block 64. If no empty zone is identified at block 55 (e.g., all zones are initialized), the method 60 may include querying the host to determine if the host identifies a zone to reset at block 67. If so, the method 60 may include resetting the identified zone at block 68, opening the identified zone at block 66, and then continuing with performing the write to NAND media at block 63 and returning the LBA to the host at block 64. If not, the method 60 may include returning an error code to the host at block 69.

Advantageously, by automatically extending host writes to any identified empty zone, some embodiments of a storage device may further reduce host bus (e.g., NVMe) utilization and a number of administration commands between the device and host. If any uninitialized zone is available, for example, the drive will independently open the zone and continue to accept write/append commands. Any suitable pointer/LBA management technology may be utilized to manage the contiguous writes to the NAND media across adjacent or non-adjacent zones (e.g., lookup tables, indirection tables, etc.).

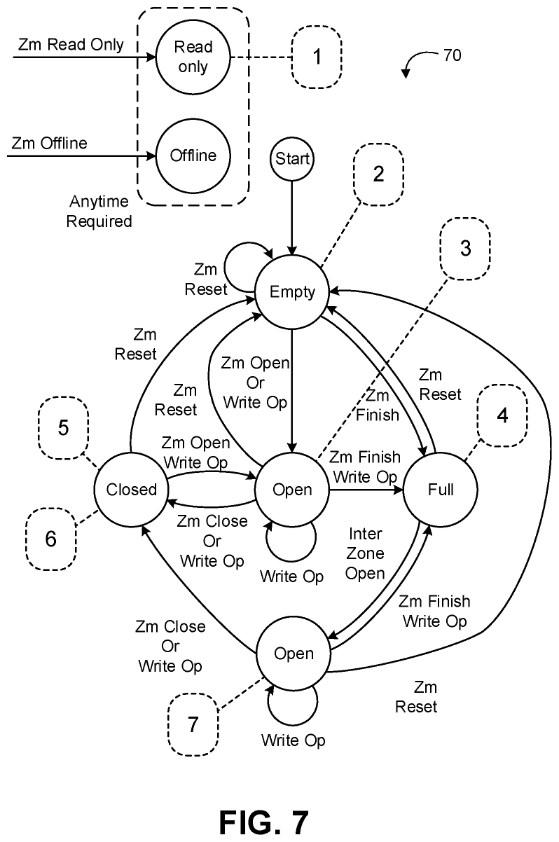

With reference to FIG. 7, an embodiment of a zone state machine 70 shows how a zone transitions from an empty state to various other states including an open state, a closed state, and a full state. Table 1 describes various commands/signals for the state machine. Table 2 describes various parameters/variables for the state machine corresponding to numbered tags on FIG. 7.

TABLE 1

| Command/ | |
|---|---|
| Signal Name | Description |
| Zm Read Only | Transitions the zone to a read only state |
| Zm Offline | Transitions the zone to an offline state |
| Zm Reset | Transitions the zone to an empty state |
| Zm Open | Transitions a zone from an empty state |
| | or closed state to an open state |
| Zm Close | Transitions a zone from an open state |
| | to a closed state |
| Zm Finish | Transitions a zone from an empty state |
| | or an open state to a full state |
| Write Op | A request to perform a write operation. |
| | Various actions/transitions |
| | are performed as shown in FIG. 7 |
| | depending on the state of the zone |
| Inter Zone | Opens a new zone for continued |
| Open | write operations across zones |

TABLE 2

| Tag | Parameters/Variables/Notes |
|---|---|
| 1 | Active = False |
| | Control = NA |
| | Write Pointer (WP) <= ZSIZE & WP > 0 |
| | Relocation in progress = status |
| 2 | Active = 0 |
| | Control = NA |
| | WP = 0 |
| 3 | Active = True |
| | Control = Write Op/Zm Finish |
| | WP <= ZSIZE & WP > 0 |
| | Relocation in progress = status |
| 4 | Active = True |
| | Control = Inter Zone Open (New zone |
| | opened, WP reset to 0) |
| | WP > ZSIZE |
| | Relocation in progress = status |
| 5 | Active = True |
| | Control = Write Op/Zm Open |
| | WP < ZSIZE & WP >= 0 |
| | Relocation in progress = status |
| 6 | Write Op for other zone can close |
| | zone when Control = Write Op |
| | Host can close any open zone with Zm Close |
| 7 | Active = True |
| | Control = Write Op/Zm Finish |
| | WP <= ZSIZE & WP > 0 |
| | Relocation in progress = status |

Anytime required, a Zm Reset command transitions the zone(s) back to the empty state. With conventional ZNS technology, zones must be opened by the host from the empty state, and if a host write continues past ZMAX, the zone becomes full and all new writes are rejected. Advantageously, some embodiments provide a zone state machine where zones may be opened from the full state, and if a host write continues past ZMAX, a new zone may be opened so that the current write may continue and new writes may continue to be accepted.

The technology discussed herein may be provided in various computing systems (e.g., including a non-mobile computing device such as a desktop, workstation, server, rack system, etc., a mobile computing device such as a smartphone, tablet, Ultra-Mobile Personal Computer (UMPC), laptop computer, ULTRABOOK computing device, smart watch, smart glasses, smart bracelet, etc., and/or a client/edge device such as an Internet-of-Things (IoT) device (e.g., a sensor, a camera, etc.)).

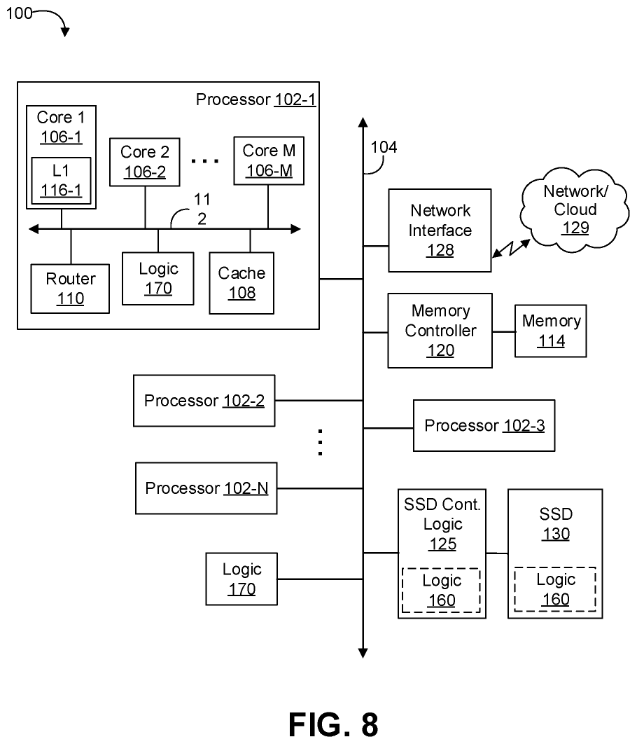

Turning now to FIG. 8, an embodiment of a computing system 100 may include one or more processors 102-1 through 102-N (generally referred to herein as “processors 102” or “processor 102”). The processors 102 may communicate via an interconnection or bus 104. Each processor 102 may include various components some of which are only discussed with reference to processor 102-1 for clarity. Accordingly, each of the remaining processors 102-2 through 102-N may include the same or similar components discussed with reference to the processor 102-1.

In some embodiments, the processor 102-1 may include one or more processor cores 106-1 through 106-M (referred to herein as “cores 106,” or more generally as “core 106”), a cache 108 (which may be a shared cache or a private cache in various embodiments), and/or a router 110. The processor cores 106 may be implemented on a single integrated circuit (IC) chip. Moreover, the chip may include one or more shared and/or private caches (such as cache 108), buses or interconnections (such as a bus or interconnection 112), logic 170, memory controllers, or other components.

In some embodiments, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that is utilized by one or more components of the processor 102-1, such as the cores 106. For example, the cache 108 may locally cache data stored in a memory 114 for faster access by the components of the processor 102. As shown in FIG. 8, the memory 114 may be in communication with the processors 102 via the interconnection 104. In some embodiments, the cache 108 (that may be shared) may have various levels, for example, the cache 108 may be a mid-level cache and/or a last-level cache (LLC). Also, each of the cores 106 may include a level 1 (L1) cache (116-1) (generally referred to herein as “L1 cache 116”). Various components of the processor 102-1 may communicate with the cache 108 directly, through a bus (e.g., the bus 112), and/or a memory controller or hub.

As shown in FIG. 8, memory 114 may be coupled to other components of system 100 through a memory controller 120. Memory 114 may include volatile memory and may be interchangeably referred to as main memory. Even though the memory controller 120 is shown to be coupled between the interconnection 104 and the memory 114, the memory controller 120 may be located elsewhere in system 100. For example, memory controller 120 or portions of it may be provided within one of the processors 102 in some embodiments.

The system 100 may communicate with other devices/systems/networks via a network interface 128 (e.g., which is in communication with a computer network and/or the cloud 129 via a wired or wireless interface). For example, the network interface 128 may include an antenna (not shown) to wirelessly (e.g., via an Institute of Electrical and Electronics Engineers (IEEE) 802.11 interface (including IEEE 802.11a/b/g/n/ac, etc.), cellular interface, 3G, 4G, LTE, BLUETOOTH, etc.) communicate with the network/cloud 129.

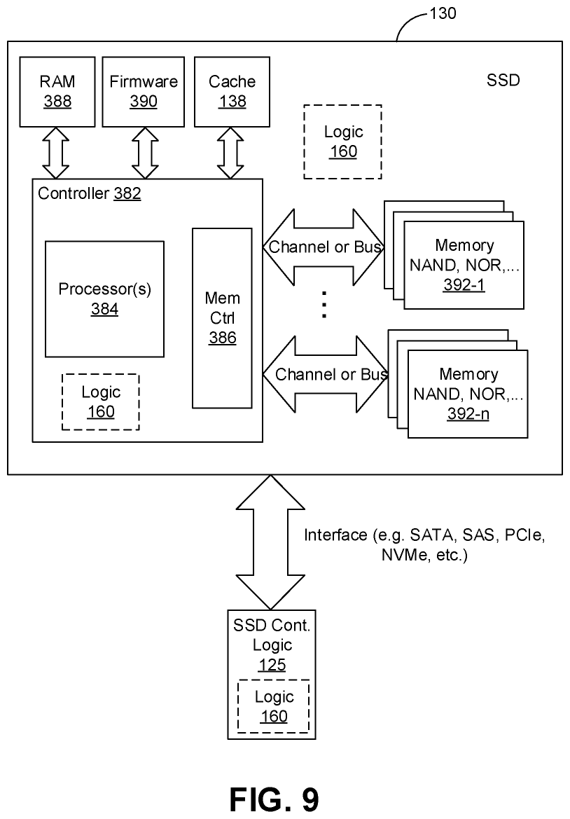

System 100 may also include a storage device such as a SSD device 130 coupled to the interconnect 104 via SSD controller logic 125. Hence, logic 125 may control access by various components of system 100 to the SSD device 130. Furthermore, even though logic 125 is shown to be directly coupled to the interconnection 104 in FIG. 8, logic 125 can alternatively communicate via a storage bus/interconnect (such as the SATA (Serial Advanced Technology Attachment) bus, Peripheral Component Interconnect (PCI) (or PCI EXPRESS (PCIe) interface), NVM EXPRESS (NVMe), etc.) with one or more other components of system 100 (for example where the storage bus is coupled to interconnect 104 via some other logic like a bus bridge, chipset, etc.) Additionally, logic 125 may be incorporated into memory controller logic (such as those discussed with reference to FIG. 9) or provided on a same integrated circuit (IC) device in various embodiments (e.g., on the same circuit board device as the SSD device 130 or in the same enclosure as the SSD device 130).

Furthermore, logic 125 and/or SSD device 130 may be coupled to one or more sensors (not shown) to receive information (e.g., in the form of one or more bits or signals) to indicate the status of or values detected by the one or more sensors. These sensor(s) may be provided proximate to components of system 100 (or other computing systems discussed herein), including the cores 106, interconnections 104 or 112, components outside of the processor 102, SSD device 130, SSD bus, SATA bus, logic 125, logic 160, logic 170, etc., to sense variations in various factors affecting power/thermal behavior of the system/platform, such as temperature, operating frequency, operating voltage, power consumption, and/or inter-core communication activity, etc.

FIG. 9 illustrates a block diagram of various components of the SSD device 130, according to an embodiment. As illustrated in FIG. 9, logic 160 may be located in various locations such as inside the SSD device 130 or controller 382, etc., and may include similar technology as discussed in connection with FIG. 8. The SSD device 130 includes a controller 382 (which in turn includes one or more processor cores or processors 384 and memory controller logic 386), cache 138, RAM 388, firmware storage 390, and one or more memory devices 392-1 to 392-N (collectively memory 392, which may include NAND flash, NOR flash, or other types of non-volatile memory). The memory 392 is coupled to the memory controller logic 386 via one or more memory channels or busses. Also, SSD device 130 communicates with logic 125 via an interface (such as a SATA, SAS, PCIe, NVMe, etc., interface). One or more of the features/aspects/operations discussed with reference to FIGS. 1-7 may be performed by one or more of the components of FIGS. 8 and/or 9. Processors 384 and/or controller 382 may compress/decompress (or otherwise cause compression/decompression of) data written to or read from memory devices 392-1 to 392-N. Also, one or more of the features/aspects/operations of FIGS. 1-7 may be programmed into the firmware 390. Further, SSD controller logic 125 may also include logic 160.

As illustrated in FIGS. 8 and 9, the SSD device 130 may include logic 160, which may be in the same enclosure as the SSD device 130 and/or fully integrated on a printed circuit board (PCB) of the SSD device 130. The system 100 may include further logic 170 outside of the SSD device 130. Advantageously, the logic 160 and/or logic 170 may include technology to implement one or more aspects of the method 20 (FIGS. 3A to 3D), the zoned namespace 40, the method 50 (FIG. 5), the method 60 (FIG. 6), the zone state machine 70 (FIG. 7), the system 10, the apparatus 15, and/or any of the features discussed herein. For example, the logic 170 may include technology to implement the host device/computer system/agent aspects of the various embodiments described herein (e.g., requesting information from the SSD device 130, sending information to the SSD device 130, requesting write operations to the SSD, identifying zones which may be re-initialized, etc.).

For example, the logic 160/170 may include technology to implement NVMe ZNS technology and to logically organize the SSD device 130 with a namespace divided into two or more zones. The logic 160 may be further configured to receive a write request for a first zone of the two or more zones of the namespace, determine if the first zone can accommodate the write request, and span the write request across a second zone of the two or more zones of the namespace if the first zone cannot accommodate the write request. If the first zone cannot accommodate the write request, for example, the logic 160 may be configured to determine if a zone adjacent to the first zone is uninitialized, and if so determined, to initialize the adjacent zone to provide the second zone, and continue the write request with the second zone. In some embodiments, if the adjacent zone is determined to be already initialized the logic 160 may be further configured to query a host (e.g., processors 102) to re-initialize the adjacent zone, and if the re-initialize query is accepted by the host, to initialize the adjacent zone to provide the second zone, and continue the write request with the second zone.

In some embodiments, the logic 160 may be configured to determine if the first zone is full, and if so determined, to identify an empty zone, reset the empty zone to provide the second zone, and continue the write request with the second zone. For example, the logic 160 may be further configured to manage a pointer to link the second zone to the first zone, and/or to query a host to identify the empty zone.

In other embodiments, the SSD device 130 may be replaced with any suitable storage/memory technology/media. In some embodiments, the logic 160/170 may be coupled to one or more substrates (e.g., silicon, sapphire, gallium arsenide, printed circuit board (PCB), etc.), and may include transistor channel regions that are positioned within the one or more substrates. In other embodiments, the SSD device 130 may include two or more types of storage media. For example, the bulk of the storage may be NAND and may further include some faster, smaller granularity accessible (e.g., byte-addressable) NVM such as INTEL 3DXP media. The SSD device 130 may alternatively, or additionally, include persistent volatile memory (e.g., battery or capacitor backed-up DRAM or SRAM). For example, the SSD device 130 may include POWER LOSS IMMINENT (PLI) technology with energy storing capacitors. The energy storing capacitors may provide enough energy (power) to complete any commands in progress and to make sure that any data in the DRAMs/SRAMs is committed to the non-volatile NAND media. The capacitors may act as backup batteries for the persistent volatile memory. As shown in FIG. 8, features or aspects of the logic 160 and/or the logic 170 may be distributed throughout the system 100, and/or co-located/integrated with various components of the system 100.

### ADDITIONAL NOTES AND EXAMPLES

Example 1 includes an electronic apparatus, comprising one or more substrates, and logic coupled to the one or more substrates, the logic to control access to a persistent storage device which is logically organized with a namespace divided into two or more zones, receive a write request for a first zone of the two or more zones of the namespace, determine if the first zone can accommodate the write request, and span the write request across a second zone of the two or more zones of the namespace if the first zone cannot accommodate the write request.

Example 2 includes the apparatus of Example 1, wherein if the first zone cannot accommodate the write request the logic is further to determine if a zone adjacent to the first zone is uninitialized, and if so determined, the logic is further to initialize the adjacent zone to provide the second zone, and continue the write request with the second zone.

Example 3 includes the apparatus of Example 2, wherein if the adjacent zone is determined to be already initialized the logic is further to query a host to re-initialize the adjacent zone, and if the re-initialize query is accepted by the host, the logic is further to initialize the adjacent zone to provide the second zone, and continue the write request with the second zone.

Example 4 includes the apparatus of any of Examples 1 to 3, wherein the logic is further to determine if the first zone is full, and if so determined, the logic is further to identify an empty zone, reset the empty zone to provide the second zone, and continue the write request with the second zone.

Example 5 includes the apparatus of Example 4, wherein the logic is further to manage a pointer to link the second zone to the first zone.

Example 6 includes the apparatus of Example 4, wherein the logic is further to query a host to identify the empty zone.

Example 7 includes the apparatus of any of Examples 1 to 6, wherein the persistent storage device comprises a solid state drive.

Example 8 includes an electronic storage system, comprising a persistent storage device logically organized with a namespace divided into two or more zones, and a controller coupled to the persistent storage device, the controller including logic to receive a write request for a first zone of the two or more zones of the namespace, determine if the first zone can accommodate the write request, and span the write request across a second zone of the two or more zones of the namespace if the first zone cannot accommodate the write request.

Example 9 includes the system of Example 8, wherein if the first zone cannot accommodate the write request the logic is further to determine if a zone adjacent to the first zone is uninitialized, and if so determined, the logic is further to initialize the adjacent zone to provide the second zone, and continue the write request with the second zone.

Example 10 includes the system of Example 9, wherein if the adjacent zone is determined to be already initialized the logic is further to query a host to re-initialize the adjacent zone, and if the re-initialize query is accepted by the host, the logic is further to initialize the adjacent zone to provide the second zone, and continue the write request with the second zone.

Example 11 includes the system of any of Examples 8 to 10, wherein the logic is further to determine if the first zone is full, and if so determined, the logic is further to identify an empty zone, reset the empty zone to provide the second zone, and continue the write request with the second zone.

Example 12 includes the system of Example 11, wherein the logic is further to manage a pointer to link the second zone to the first zone.

Example 13 includes the system of Example 11, wherein the logic is further to query a host to identify the empty zone.

Example 14 includes the system of any of Examples 8 to 13, wherein the persistent storage device comprises a solid state drive.

Example 15 includes a method of controlling storage, comprising controlling access to a persistent storage device which is logically organized with a namespace divided into two or more zones, receiving a write request for a first zone of the two or more zones of the namespace, determining if the first zone can accommodate the write request, and spanning the write request across a second zone of the two or more zones of the namespace if the first zone cannot accommodate the write request.

Example 16 includes the method of Example 15, wherein if the first zone cannot accommodate the write request the method further comprises determining if a zone adjacent to the first zone is uninitialized, and if so determined, the method further comprising initializing the adjacent zone to provide the second zone, and continuing the write request with the second zone.

Example 17 includes the method of Example 16, wherein if the adjacent zone is determined to be already initialized the method further comprises querying a host to re-initialize the adjacent zone, and if the re-initialize query is accepted by the host, the method further comprising initializing the adjacent zone to provide the second zone, and continuing the write request with the second zone.

Example 18 includes the method of any of Examples 15 to 17, further comprising determining if the first zone is full, and if so determined, the method further comprising identifying an empty zone, resetting the empty zone to provide the second zone, and continuing the write request with the second zone.

Example 19 includes the method of Example 18, further comprising managing a pointer to link the second zone to the first zone.

Example 20 includes the method of Example 18, further comprising querying a host to identify the empty zone.

Example 21 includes the method of any of Examples 15 to 20, wherein the persistent storage device comprises a solid state drive.

Example 22 includes at least one non-transitory one machine readable medium comprising a plurality of instructions that, in response to being executed on a computing device, cause the computing device to control access to a persistent storage device which is logically organized with a namespace divided into two or more zones, receive a write request for a first zone of the two or more zones of the namespace, determine if the first zone can accommodate the write request, and span the write request across a second zone of the two or more zones of the namespace if the first zone cannot accommodate the write request.

Example 23 includes the at least one non-transitory one machine readable medium of Example 22, comprising a plurality of further instructions that, in response to being executed on the computing device, cause the computing device to determine if a zone adjacent to the first zone is uninitialized if the first zone cannot accommodate the write request, and if so determined, cause the computing device to initialize the adjacent zone to provide the second zone, and continue the write request with the second zone.

Example 24 includes the at least one non-transitory one machine readable medium of Example 23, comprising a plurality of further instructions that, in response to being executed on the computing device, cause the computing device to query a host to re-initialize the adjacent zone if the adjacent zone is determined to be already initialized, and if the re-initialize query is accepted by the host, cause the computing device to initialize the adjacent zone to provide the second zone, and continue the write request with the second zone.

Example 25 includes the at least one non-transitory one machine readable medium of any of Examples 22 to 24, comprising a plurality of further instructions that, in response to being executed on the computing device, cause the computing device to determine if the first zone is full, and if so determined, cause the computing device to identify an empty zone, reset the empty zone to provide the second zone, and continue the write request with the second zone.

Example 26 includes the at least one non-transitory one machine readable medium of Example 25, comprising a plurality of further instructions that, in response to being executed on the computing device, cause the computing device to manage a pointer to link the second zone to the first zone.

Example 27 includes the at least one non-transitory one machine readable medium of Example 25, comprising a plurality of further instructions that, in response to being executed on the computing device, cause the computing device to query a host to identify the empty zone.

Example 28 includes the at least one non-transitory one machine readable medium of any of Examples 22 to 27, wherein the persistent storage device comprises a solid state drive.

Example 29 includes a storage controller apparatus, comprising means for controlling access to a persistent storage device which is logically organized with a namespace divided into two or more zones, means for receiving a write request for a first zone of the two or more zones of the namespace, means for determining if the first zone can accommodate the write request, and means for spanning the write request across a second zone of the two or more zones of the namespace if the first zone cannot accommodate the write request.

Example 30 includes the apparatus of Example 29, wherein if the first zone cannot accommodate the write request the apparatus further comprises means for determining if a zone adjacent to the first zone is uninitialized, and if so determined, the apparatus further comprising means for initializing the adjacent zone to provide the second zone, and means for continuing the write request with the second zone.

Example 31 includes the apparatus of Example 30, wherein if the adjacent zone is determined to be already initialized the apparatus further comprises means for querying a host to re-initialize the adjacent zone, and if the re-initialize query is accepted by the host, the apparatus further comprising means for initializing the adjacent zone to provide the second zone, and means for continuing the write request with the second zone.

Example 32 includes the apparatus of any of Examples 29 to 31, further comprising means for determining if the first zone is full, and if so determined, the apparatus further comprising means for identifying an empty zone, means for resetting the empty zone to provide the second zone, and means for continuing the write request with the second zone.

Example 33 includes the apparatus of Example 32, further comprising means for managing a pointer to link the second zone to the first zone.

Example 34 includes the apparatus of Example 32, further comprising means for querying a host to identify the empty zone.

Example 35 includes the apparatus of any of Examples 29 to 34, wherein the persistent storage device comprises a solid state drive.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C. Various components of the systems described herein may be implemented in software, firmware, and/or hardware and/or any combination thereof. For example, various components of the systems or devices discussed herein may be provided, at least in part, by hardware of a computing SoC such as may be found in a computing system such as, for example, a smart phone. Those skilled in the art may recognize that systems described herein may include additional components that have not been depicted in the corresponding figures. For example, the systems discussed herein may include additional components such as bit stream multiplexer or de-multiplexer modules and the like that have not been depicted in the interest of clarity.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

What is claimed is:

1. An electronic apparatus, comprising:
one or more substrates; and
logic coupled to the one or more substrates, the logic to:
control access to a persistent storage device which is logically organized with a namespace divided into two or more zones,
receive a write request for a first zone of the two or more zones of the namespace,
determine if the first zone can accommodate the write request, and
span the write request across a second zone of the two or more zones of the namespace if the first zone cannot accommodate the write request.

2. The apparatus of claim 1, wherein if the first zone cannot accommodate the write request the logic is further to determine if a zone adjacent to the first zone is uninitialized, and if so determined, the logic is further to:
initialize the adjacent zone to provide the second zone; and
continue the write request with the second zone.

3. The apparatus of claim 2, wherein if the adjacent zone is determined to be already initialized the logic is further to query a host to re-initialize the adjacent zone, and if the re-initialize query is accepted by the host, the logic is further to:
initialize the adjacent zone to provide the second zone; and
continue the write request with the second zone.

4. The apparatus of claim 1, wherein the logic is further to determine if the first zone is full, and if so determined, the logic is further to:
identify an empty zone;
reset the empty zone to provide the second zone; and
continue the write request with the second zone.

5. The apparatus of claim 4, wherein the logic is further to:
manage a pointer to link the second zone to the first zone.

6. The apparatus of claim 4, wherein the logic is further to:
query a host to identify the empty zone.

7. The apparatus of claim 1, wherein the persistent storage device comprises a solid state drive.

8. An electronic storage system, comprising:
a persistent storage device logically organized with a namespace divided into two or more zones; and
a controller coupled to the persistent storage device, the controller including logic to:
receive a write request for a first zone of the two or more zones of the namespace,
determine if the first zone can accommodate the write request, and
span the write request across a second zone of the two or more zones of the namespace if the first zone cannot accommodate the write request.

9. The system of claim 8, wherein if the first zone cannot accommodate the write request the logic is further to determine if a zone adjacent to the first zone is uninitialized, and if so determined, the logic is further to:
initialize the adjacent zone to provide the second zone; and
continue the write request with the second zone.

10. The system of claim 9, wherein if the adjacent zone is determined to be already initialized the logic is further to query a host to re-initialize the adjacent zone, and if the re-initialize query is accepted by the host, the logic is further to:
initialize the adjacent zone to provide the second zone; and
continue the write request with the second zone.

11. The system of claim 8, wherein the logic is further to determine if the first zone is full, and if so determined, the logic is further to:
identify an empty zone;
reset the empty zone to provide the second zone; and
continue the write request with the second zone.

12. The system of claim 11, wherein the logic is further to:
manage a pointer to link the second zone to the first zone.

13. The system of claim 11, wherein the logic is further to:
query a host to identify the empty zone.

14. The system of claim 8, wherein the persistent storage device comprises a solid state drive.

15. A method of controlling storage, comprising:
controlling access to a persistent storage device which is logically organized with a namespace divided into two or more zones;
receiving a write request for a first zone of the two or more zones of the namespace;
determining if the first zone can accommodate the write request; and
spanning the write request across a second zone of the two or more zones of the namespace if the first zone cannot accommodate the write request.

16. The method of claim 15, wherein if the first zone cannot accommodate the write request the method further comprises determining if a zone adjacent to the first zone is uninitialized, and if so determined, the method further comprising:
initializing the adjacent zone to provide the second zone; and
continuing the write request with the second zone.

17. The method of claim 16, wherein if the adjacent zone is determined to be already initialized the method further comprises querying a host to re-initialize the adjacent zone, and if the re-initialize query is accepted by the host, the method further comprising:
initializing the adjacent zone to provide the second zone; and
continuing the write request with the second zone.

18. The method of claim 15, further comprising determining if the first zone is full, and if so determined, the method further comprising:
identifying an empty zone;
resetting the empty zone to provide the second zone; and
continuing the write request with the second zone.

19. The method of claim 18, further comprising:
managing a pointer to link the second zone to the first zone.

20. The method of claim 18, further comprising:
querying a host to identify the empty zone.
